(19) United States
(12) Patent Application Publication
(10) Pub. No.: US 2015/0060744 A1
(43) Pub. Date: Mar. 5, 2015

(54) TRIARYLMETHANE BLUE DYE COMPOUND, BLUE RESIN COMPOSITION FOR COLOR FILTER CONTAINING SAME AND COLOR FILTER USING SAME

(71) Applicant: KYUNG SYNTHETIC CO., LTD., Incheon (KR)

(72) Inventors: Soonhyun Park, Gyeonggi-do (KR); Jeong Gi Kim, Gyeonggi-do (KR); Jung Rok Kim, Seoul (KR); Do Kyung Lee, Incheon (KR); Heon Park, Gyeonggi-do (KR)

(21) Appl. No.: 14/388,969

(22) PCT Filed: Feb. 27, 2013
(86) PCT No.: PCT/KR2013/001566

§ 371 Date: Sep. 29, 2014

(30) Foreign Application Priority Data
Mar. 30, 2012 (KR) 10-2012-0033470

(51) Int. Cl. C09B 11/12; G02B 5/22; C08F 36/20

(52) U.S. Cl. CPC C09B 11/12; C08F 36/20; G02B 5/223
USPC 252/586; 560/221; 526/243

(57) ABSTRACT

The present disclosure relates to a blue dye compound for a color filter and a coloring resin composition for a color filter containing the same. Since the blue resin composition according to the present disclosure, which contains the novel triarylmethane blue dye compound or the polymer dye compound obtained using the same as a monomer, has superior solubility in an organic solvent such as propylene glycol monomethyl ether acetate (PGMEA), cyclohexanone, etc. as well as superior miscibility with another pigment and high brightness, it can be used to prepare a color filter exhibiting superior heat resistance, light resistance and brightness.

### TECHNICAL FIELD

The present disclosure relates to a blue dye compound for a color filter and a blue resin composition for a color filter containing the same. More particularly, it relates to a novel triarylmethane dye compound exhibiting improved solubility, high heat resistance and high brightness as compared to the existing dye, a blue resin composition for a color filter containing the same and a color filter including the same.

### BACKGROUND ART

A liquid crystal display displays images using optical and electrical properties of a liquid crystal material. The liquid crystal display is advantageous over CRTs, plasma display panels, etc. in that it is lightweight, consumes less power and operates at lower voltage. The liquid crystal display includes a liquid crystal layer disposed between glass substrates. Light produced by a light source passes through the liquid crystal layer and the liquid crystal layer controls light transmittance. After passing through the liquid crystal layer, the light passes through a color filter layer. A full-color display is realized through additive color mixing of the light that has passed through the color filter layer.

In general, a color filter used for a liquid crystal display is prepared by staining, printing, electrodeposition or pigment dispersion. Although methods of using a dye have been considered from the past, use of a dye is disadvantageous as compared to a pigment in terms of heat resistance, light resistance, chemical resistance, etc. and is also disadvantageous economically because of a complicated process. Thus, pigment dispersion is usually employed at present. Although a pigment is less transparent than a dye, the problem has been solved through advancement in techniques for pulverizing and dispersing pigments. A color filter prepared by the pigment dispersion method is stable against light, heat, solvent, etc., and it is easy to prepare a color filter for a large-screen, high-precision color display through patterning by photolithography. For this reason, the method is the most widely employed at present.

Red, green and blue pigments are used to form a RGB color filter for a pigment-dispersed color resist. In addition, yellow or violet pigments may be further included to more effectively display colors. A method of preparing a color filter by pigment dispersion is as follows. First, a color resist solution is coated on a substrate using a spin coater and a coating film is formed by drying. Then, a color pixel obtained by patterning, exposing and developing the coating film is heat-treated at high temperature to obtain a pattern of a first color. This procedure is repeated for each color. The most important factors affecting the performance of the color resist are the characteristics, dispersibility and dispersion state of the pigment used as a coloring agent. Recently, with the trend toward large-sized, high-definition LCDs, requirements on high transmittance, high contrast ratio, narrow black matrix width, high reliability, etc. are ever increasing for a color filter. To satisfy these requirements, pigments are pulverized as much as possible to satisfy color properties such as brightness, contrast ratio, etc.

However, the pigment dispersion is problematic in that the pigment in particle state scatters light and the rapidly increased surface area of the pigment due to small particle size leads to formation of nonuniform pigment particles because of poor dispersion stability. As a result, it is difficult to satisfy the quality requirements of high brightness, high contrast ratio, high definition, etc. Furthermore, to prepare the pigment dispersion, synthesized pigment powder cannot be used as it is and a pigmentation process such as salt milling is necessary for stable dispersion and particle size reduction. Such a post-treatment process is not only undesirable in terms of environmental protection but also it requires many additives such as a dispersant, a pigment derivative, etc. to maintain stable dispersion as well as a very complicated and intricate process. In addition, the pigment dispersion requires complicated storage and transport conditions to maintain optimum quality.

Use of a dye instead of the pigment as a coloring agent has been studied to solve these problems and achieve high brightness, high contrast ratio and high resolution. In particular, use of triarylmethane dyes as blue coloring agents has been attempted a lot. Although the triarylmethane dye exhibits high transmittance at 420-450 nm and thus is suitable as a blue dye compound for a color filter in general, it has poor solubility in solvents used for a coloring composition for a color filter or has poor heat resistance. As the solvents used for a coloring composition for a color filter, propylene glycol monomethyl ether acetate (PGMEA), propylene glycol monomethyl ether (PGME), cyclohexanone, etc. are mainly used. Although the generally known dyes have good solubility in cyclohexanone, they have low solubility in PGMEA or PGME. But, because cyclohexanone is recognized as an environmentally harmful substance, a dye exhibiting high solubility in PGMEA or PGME is necessary.

Patent document 1 (Japanese Patent Publication No. 2008-304766) discloses a pigment having a triarylmethane structure and a coloring resin composition and a color filter containing the same. Patent document 2 (Japanese Patent Publication No. 2011-7847) discloses a salt compound consisting of a triarylmethane cation and a naphtholsulfonate, naphthalenesulfonate or naphthylamine sulfonate anion having at least two sulfonyl groups and a coloring resin composition and a color filter containing the same. However, these compounds have low solubility in propylene glycol monomethyl ether acetate (PGMEA), etc. and also have poor heat resistance.

Patent document 3 (Japanese Patent Publication No. 2010-204132) discloses a salt compound consisting of a triarylmethane cation and a phthalocyanine sulfonate anion. Although the compound exhibits significantly improved heat resistance over the compounds of Patent documents 1 and 2, it still has low solubility in an ester-based organic solvent such as PGMEA.

### DISCLOSURE

### Technical Problem

The present disclosure is directed to providing a novel triarylmethane blue dye compound exhibiting superior solubility as well as heat resistance, light resistance and brightness and a blue resin composition for a color filter containing the same.

The present disclosure is also directed to providing a color filter using the blue resin composition.

### Technical Solution

In a general aspect, the present disclosure provides a triarylmethane blue dye compound represented by [Chemical Formula 1]:

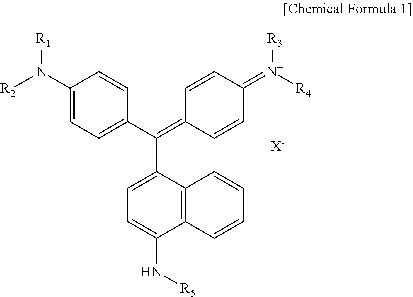

wherein

X⁻ is a trifluoromethanesulfonate or bis(trifluoromethane)sulfonimide anion,

each of R₁, R₂, R₃ and R₄ is independently selected from hydrogen, a substituted or unsubstituted C₁-C₁₀ alkyl group, a substituted or unsubstituted C₆-C₁₀ aromatic hydrocarbon and R₆ represented by [Structural Formula 1],

at least one of R₁, R₂, R₃ and R₄ includes R₆ and

R₅ is phenyl, C₁-C₈ alkoxyphenyl or halogenated phenyl

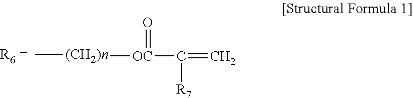

wherein

n is an integer from 1 to 10 and R₇ is hydrogen or methyl.

In another general aspect, the present disclosure provides a homopolymer or copolymer blue dye compound containing a structure represented by [Chemical Formula 2] as a polymer compound obtained from the triarylmethane compound represented by [Chemical Formula 1] as a monomer:

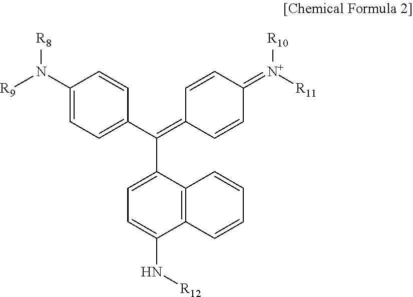

wherein

X⁻ is a trifluoromethanesulfonate or bis(trifluoromethane)sulfonimide anion,

each of R₈, R₉, R₁₀ and R₁₁ is independently selected from hydrogen, a substituted or unsubstituted C₆-C₁₀ aromatic hydrocarbon and R₁₃ represented by [Structural Formula 2],

at least one of R₈, R₉, R₁₀ and R₁₁ includes R₁₃ and

R₁₂ is phenyl, C₁-C₈ alkoxyphenyl or halogenated phenyl

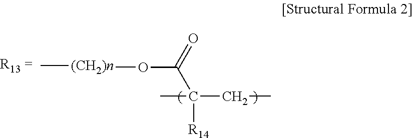

wherein

n is an integer from 1 to 10 and R₁₄ is hydrogen or methyl.

The polymer compound may have a weight-average molecular weight of 2000-150,000, specifically 2000-30000.

In another general aspect, the present disclosure provides a blue resin composition for a color filter, containing: a blue dye compound; a binder resin; a reactive unsaturated compound; a polymerization initiator; an organic solvent; and an additive, wherein the blue dye compound is the blue dye compound represented by [Chemical Formula 1] or the homopolymer or copolymer blue dye compound containing the structure represented by [Chemical Formula 2] as a polymer compound obtained from the compound represented by [Chemical Formula 1] as a monomer.

In an exemplary embodiment of the present disclosure, the blue dye compound may further contain, together with the polymer compound containing the structure represented by [Chemical Formula 1] or [Chemical Formula 2], one or more selected from a xanthene dye, a cyanine dye and an azaporphyrin dye.

In another exemplary embodiment of the present disclosure, the blue dye compound may be contained in an amount of 0.01-50 wt % based on the total weight of the blue resin composition.

In another exemplary embodiment of the present disclosure, the blue resin composition for a color filter may further contain a blue pigment, if necessary, and the blue pigment may be a copper phthalocyanine-based blue pigment.

In another exemplary embodiment of the present disclosure, the reactive unsaturated compound may be selected from a group consisting of a thermosetting monomer or oligomer, a photocurable monomer or oligomer and a combination thereof.

In another exemplary embodiment of the present disclosure, the polymerization initiator may be selected from a group consisting of a thermosetting initiator, a photocuring initiator and a combination thereof.

In another general aspect, the present disclosure provides a color filter prepared using the blue resin composition for a color filter.

### Advantageous Effects

A triarylmethane blue dye compound according to the present disclosure has superior solubility in propylene glycol monomethyl ether acetate (PGMEA) and high heat resistance and brightness properties. Accordingly, it can be used to prepare a color filter exhibiting superior heat resistance, light resistance and brightness.

### BRIEF DESCRIPTION OF DRAWINGS

FIG. 1 shows UV-vis spectra of blue resin compositions of Examples 1-6 and Comparative Examples 1-2 after exposure to light.

FIG. 2 shows UV-vis spectra of blue resin compositions of Examples 1-6 and Comparative Examples 1-2 after postbaking at 220° C. for 30 minutes.

### BEST MODE

Hereinafter, the present disclosure is described in further detail.

Recently, dyes exhibiting various transmittance properties are being developed as coloring agents for a color filter. However, development of a dye which has a very small particle size in the order of sub-nanometers in solution state is necessary to satisfy high solubility in an organic solvent as well as high transmittance, heat resistance and brightness.

A blue dye compound and a polymer according to the present disclosure exhibit superior solubility as well as high heat resistance, brightness and light resistance and thus are suitable for use in a blue resin composition for a color filter.

The blue dye compound according to the present disclosure may be a blue dye compound represented by [Chemical Formula 1]:

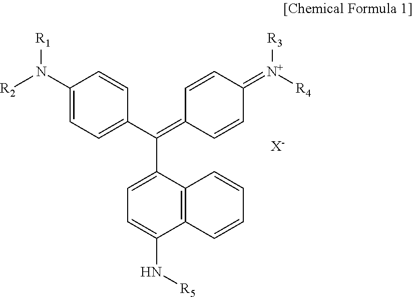

wherein

X⁻ is a trifluoromethanesulfonate or bis(trifluoromethane)sulfonimide anion,

each of R₁, R₂, R₃ and R₄ is independently selected from hydrogen, a substituted or unsubstituted C₁-C₁₀ alkyl group, a substituted or unsubstituted C₆-C₁₀ aromatic hydrocarbon and R₆ represented by [Structural Formula 1],

at least one of R₁, R₂, R₃ and R₄ and includes R₆ and

R₅ is phenyl, C₁-C₈ alkoxyphenyl or halogenated phenyl

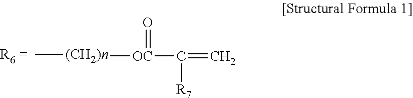

wherein

n is an integer from 1 to 10 and R₇ is hydrogen or methyl.

Also, the blue dye compound according to the present disclosure may be a homopolymer or copolymer blue dye compound containing a structure represented by [Chemical Formula 2] as a polymer compound obtained from the triarylmethane compound represented by [Chemical Formula 1] as a monomer:

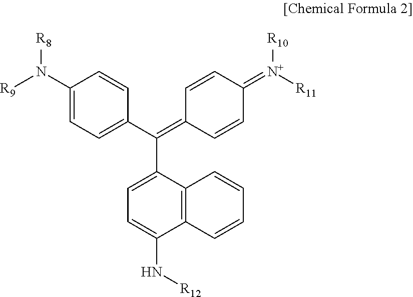

wherein

X⁻ is a trifluoromethanesulfonate or bis(trifluoromethane)sulfonimide anion,

each of R₈, R₉, R₁₀ and R₁₁ is independently selected from hydrogen, a substituted or unsubstituted C₆-C₁₀ aromatic hydrocarbon and R₁₃ represented by [Structural Formula 2],

at least one of R₈, R₉, R₁₀ and R₁₁ includes R₁₃ and

R₁₂ is phenyl, C₁-C₈ alkoxyphenyl or halogenated phenyl

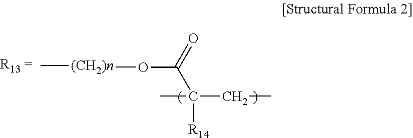

wherein

n is an integer from 1 to 10 and R₁₄ is hydrogen or methyl.

A blue resin composition for a color filter according to the present disclosure may contain, together the blue dye compound, a binder resin, a reactive unsaturated compound, a polymerization initiator, an organic solvent and an additive and may further contain a blue pigment, if necessary.

The blue dye compound may optionally contain, together with the compound represented by [Chemical Formula 1] or the polymer compound containing the structure represented by [Chemical Formula 2], one or more another dye. The additionally contained dye may be one commonly used in a color filter blue resin composition such as a xanthene dye, a cyanine dye, an azaporphyrin dye, etc.

The compound represented by [Chemical Formula 1], the polymer compound containing the structure represented by [Chemical Formula 2] and the optionally contained another dye may be contained in an amount of 0.01-50 wt % based on the total weight of the blue resin composition. When the blue dye compound is contained in the above-described range, the blue resin composition may have superior solubility in a solvent as well as high brightness and superior heat resistance and light resistance.

The blue pigment may be one or more blue pigment selected from ones commonly used for a coloring resin composition for a color filter. For example, a copper phthalocyanine-based blue pigment may be used. Examples of the blue pigment may include the compounds classified as pigments in Colour Index (published by the Society of Dyers and Colourists). Specific examples may include Color Index (C.I.) Pigment Blue 1, 15, 15:1, 15:2, 15:3, 15:4, 15:6, 16, 60, etc.

The blue resin composition for a color filter, which contains the compound represented by [Chemical Formula 1] or the polymer compound containing the structure represented by [Chemical Formula 2], may have superior transmittance at 420-450 nm and thus may exhibit high brightness.

The binder resin is not particularly limited as long as it is a resin capable of exhibiting binding property. In particular, generally known film-forming resins may be used.

For example, a cellulose resin, particularly carboxymethyl hydroxyethyl cellulose or hydroxyethyl cellulose, an acrylate resin, an alkyd resin, a melamine resin, an epoxy resin, a polyvinyl alcohol resin, a polyvinylpyrrolidone resin, a polyamide resin, a polyamide-imine resin, a polyimide resin, etc. may be used.

Also, the binder resin may be a resin having a photopolymerizable unsaturated bond, e.g., an acrylate resin. In particular, a homopolymer or a copolymer of a polymerizable monomer, e.g., a copolymer of a polymerizable monomer having a carboxyl group such as methyl methacrylate, ethyl methacrylate, propyl methacrylate, butyl methacrylate, styrene and styrene derivatives, methacrylic acid, itaconic acid, maleic acid, maleic anhydride and monoalkyl maleate and a polymerizable monomer such as methacrylic acid, styrene and styrene derivatives may be useful.

Specific examples include a reaction product of a compound containing an oxirane ring and an ethylene-based unsaturated compound, e.g., glycidyl (meth)acrylate, acryloyl glycidyl ether, monoalkyl glycidyl itaconate, etc., and a carboxyl-containing polymer compound and a reaction product of a compound containing a hydroxyl group and an ethylene-based unsaturated compound (unsaturated alcohol), e.g., allyl alcohol, 2-buten-4-ol, oleyl alcohol, 2-hydroxyethyl (meth)acrylate, N-methylolacrylamide, etc. and a carboxyl-containing polymer compound. The binder may also contain an unsaturated compound without an isocyanate group.

The equivalent degree of unsaturation of the binder (the molecular weight of the binder per unsaturated compound) may be generally 200-3,000, specifically 230-1,000, to provide suitable photopolymerization properties and film hardness. The binder may have an acid value of generally 20-300, specifically 40-200, to provide sufficient alkali developing properties after exposure. The binder may have an average molecular weight of 1,500-200,000 g/mol, in particular 10,000-50,000 g/mol.

The reactive unsaturated compound may be selected from a group consisting of a thermosetting monomer or oligomer, a photocurable monomer or oligomer and a combination thereof. Specifically, it may be a photocurable monomer and may be one containing one or more reactive double bond and an additional reactive group in the molecule.

In this regard, useful photocurable monomers include, in particular, a reactive solvent or a reactive diluent, e.g., mono-, di-, tri- and poly-functional acrylate and methacrylate, vinyl ether, glycidyl ether, etc. Additional reactive groups include allyl, hydroxyl, phosphate, urethane, secondary amine, N-alkoxymethyl, etc.

These types of monomers are known in the art and are described, for example, in [Roempp, Lexikon, Lacke und Druckfarben, Dr. Ulrich Zorll, Thimem Verlag Stuttgart-New York, 1998, pp. 491-492]. Selection of the monomer depends on the type and intensity of radiation used, target reaction using a photoinitiator and film properties. The photocurable monomer may be used alone or in combination.

The polymerization initiator may be a thermosetting initiator, a photocuring initiator or a combination thereof. Specifically, it may be a photocuring initiator. The photocuring initiator is a compound that forms a reaction intermediate capable of inducing polymerization of the monomer and/or the binder by absorbing visible or UV light. The photocuring initiator is also known in the art and is described, for example, in [Roempp, Lexikon, Lacke und Druckfarben, Dr. Ulrich Zorll, Thimem Verlag Stuttgart-New York, 1998, pp. 445-446].

The organic solvent may be, for example, a ketone, alkylene glycol ether, alcohol or aromatic compound. Ketones include acetone, methyl ethyl ketone, cyclohexanone, etc., alkylene glycol ethers include methyl cellosolve (ethylene glycol monomethyl ether), butyl cellosolve (ethylene glycol monobutyl ether), methyl cellosolve acetate, ethyl cellosolve acetate, butyl cellosolve acetate, ethylene glycol monopropyl ether, ethylene glycol monohexyl ether, ethylene glycol dimethyl ether, diethylene glycol ethyl ether, propylene glycol monomethyl ether, propylene glycol monoethyl ether, propylene glycol monopropyl ether, propylene glycol monobutyl ether, propylene glycol monomethyl ether acetate, diethylene glycol methyl ether acetate, diethylene glycol ethyl ether acetate, diethylene glycol propyl ether acetate, diethylene glycol isopropyl ether acetate, diethylene glycol butyl ether acetate, diethylene glycol t-butyl ether acetate, triethylene glycol methyl ether acetate, triethylene glycol ethyl ether acetate, triethylene glycol propyl ether acetate, triethylene glycol isopropyl ether acetate, triethylene glycol, triethylene glycol butyl ether acetate, triethylene glycol t-butyl ether acetate, etc., alcohols include methyl alcohol, ethyl alcohol, isopropyl alcohol, n-butyl alcohol, 3-methyl-3-methoxybutanol, etc., and aromatic compounds include benzene, toluene, xylene, N-methyl-2-pyrrolidone, ethyl N-hydroxymethylpyrrolidone-2-acetate, etc. Examples of other solvents include 1,2-propanediol diacetate, 3-methyl-3-methyl-3methoxybutyl acetate, ethyl acetate, tetrahydrofuran, etc. These organic solvents may be used alone or in combination.

The additive is not particularly limited so long as it does not negatively affect the desired effect. Specific examples include fatty acids, fatty amines, alcohols, bean oils, waxes, rosins, resins, benzotriazole derivatives, etc. used to improve surface texture. More specifically, useful fatty acids may include stearic acid or behenic acid and useful fatty amines may include stearylamine.

### MODE FOR INVENTION

Hereinafter, the present disclosure will be described in detail through examples. However, the following examples are for illustrative purposes only and it will be apparent to those of ordinary skill in the art that the scope of the present disclosure is not limited by the examples.

### EXAMPLES

### (1) Synthesis of Compound of [Chemical Formula I]

A compound represented by [Chemical Formula I] was synthesized according to [Scheme 1].

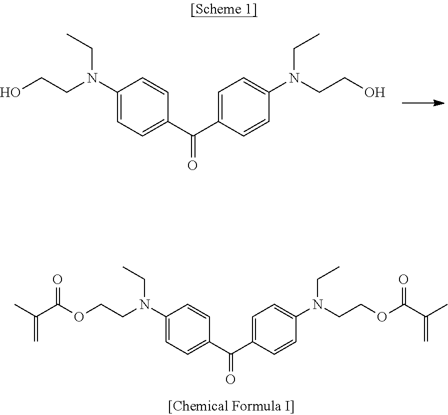 [SMILES: CCN(CCO)c1ccc(C(=O)c2ccc(N(CC)CCO)cc2)cc1 ; C=C(C)C(=O)OCCN(CC)c1ccc(C(=O)c2ccc(N(CC)CCOC(=O)C(=C)C)cc2)cc1]

Bis(N-ethyl-N-hydroxyethyl)aminobenzophenone (28.52 g, 80.00 mmol) and triethylamine (17.80 g, 176.00 mmol) were added to dichloromethane (50 mL) and dissolved by stirring. Then, after adding methacrylic anhydride (13.56 g, 176.00 mmol), the mixture was heated to 40° C. and maintained at the temperature. Upon completion of reaction, water was added. After phase separation, saturated sodium chloride solution (20 mL) was added and the mixture was stirred for 30 minutes. After phase separation, the organic layer was dried under reduced pressure and purified to obtain a compound of [Chemical Formula I] (32.72 g, 66.40 mmol).

### (2) Synthesis of Compound of [Chemical Formula II]

A compound represented by [Chemical Formula II] was synthesized according to [Scheme 2].

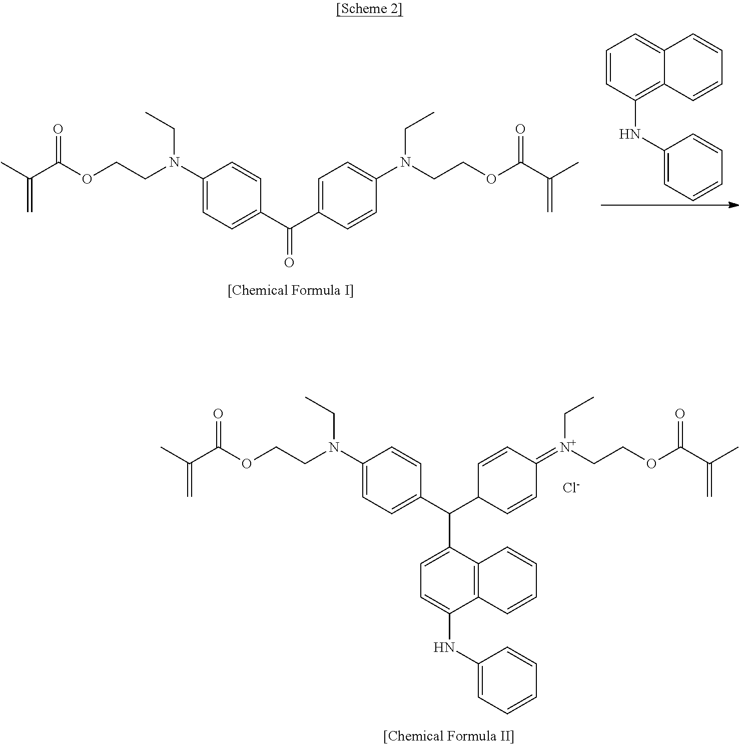

The compound of [Chemical Formula I] (32.72 g, 66.40 mmol) was added to chloroform (500 mL) and stirred. Then, phosphorus oxychloride (49.08 g, 332.00 mmol) was added and the mixture was stirred for 15 minutes. After adding N-phenyl-1-naphthylamine (14.56 g, 66.80 mmol), the mixture was refluxed. Upon completion of reaction, the reaction mixture was cooled to room temperature and stirred after adding water. After phase separation followed by concentration under reduced pressure, the obtained compound was purified to obtain a compound of [Chemical Formula II] (26.36 g, 36.00 mmol).

### Synthesis Example 1

### Synthesis of Compound of [Chemical Formula III]

A compound represented by [Chemical Formula III] was synthesized according to [Scheme 3].

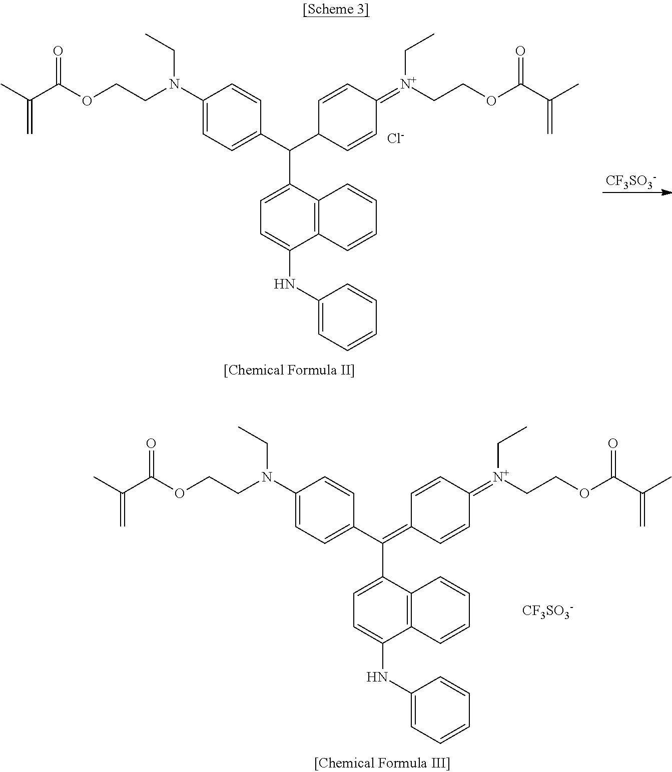

The compound of [Chemical Formula II] (10.00 g, 13.26 mmol) was dissolved by adding methanol (100 mL) and 20% aqueous solution of sodium trifluoromethanesulfonate (2.50 g, 14.58 mmol) was added. After filtration, the obtained compound was dissolved with CHCl₃, washed with water and concentrated under reduced pressure to obtain a compound of [Chemical Formula III] (6.92 g, 8.48 mmol).

### Synthesis Example 2

### Synthesis of Compound of [Chemical Formula IV]

A compound represented by [Chemical Formula IV] was synthesized according to [Scheme 4].

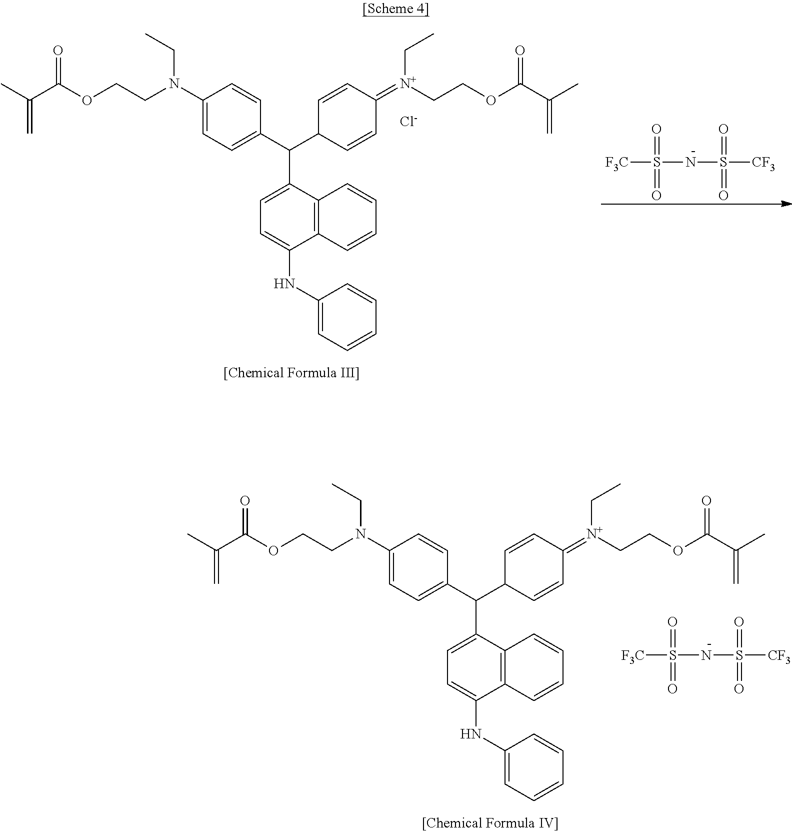

The compound of [Chemical Formula III] (10.00 g, 13.26 mmol) was dissolved by adding methanol (100 mL) and 20% aqueous solution of lithium bis(trifluoromethane)sulfonimide (2.09 g, 7.29 mmol) was added. After filtration, the obtained compound was dissolved with CHCl₃, washed with water and concentrated under reduced pressure to obtain a compound of [Chemical Formula IV] (9.06 g, 9.28 mmol).

### Synthesis Example 3

### Synthesis of Polymer Compound Using Compound of [Chemical Formula III]

A polymer compound was synthesized using the compound of [Chemical Formula III] according to [Scheme 5].

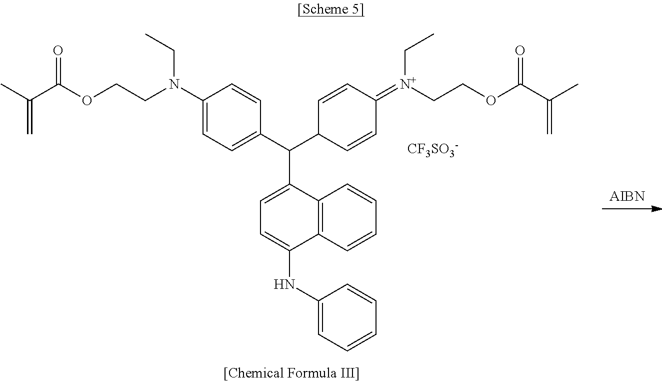

Under nitrogen atmosphere, methyl ethyl ketone (30 g) was heated to 70° C. The compound of [Chemical Formula III] (2.54 g) and 2,2′-azobisisobutyronitrile (0.16 g) dissolved in methyl ethyl ketone (20 g) were added to the reactor for 3 hours while maintaining temperature at 70° C. After the addition was completed, the mixture was maintained at 70° C. for 15 hours. After partially concentrating the methyl ethyl ketone and adding the reaction mixture to hexane, the resulting product was filtered and dried to obtain a polymer compound (2.48 g).

Number-average molecular weight=3269, weight-average molecular weight=3492, polydispersity=1.07.

### Synthesis Example 4

### Synthesis of Polymer Compound Using Compound of [Chemical Formula III]

A polymer compound was synthesized using the compound of [Chemical Formula III] according to [Scheme 6].

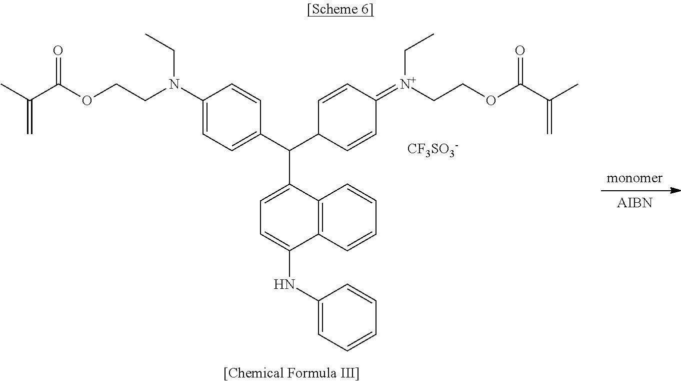

Under nitrogen atmosphere, methyl ethyl ketone (30 g) was heated to 70° C. The compound of [Chemical Formula III] (2.54 g), 2,2′-azobisisobutyronitrile (0.25 g), benzyl methacrylate (0.51 g), methacrylic acid (0.51 g) and N-phenylmaleimide (0.42 g) dissolved in methyl ethyl ketone (50 g) were added to the reactor for 3 hours while maintaining temperature at 70° C. After the addition was completed, the mixture was maintained at 70° C. for 15 hours. After partially concentrating the methyl ethyl ketone and adding the reaction mixture to hexane, the resulting product was filtered and dried to obtain a polymer compound (3.85 g).

Number-average molecular weight=3925, weight-average molecular weight=4266, polydispersity=1.09.

### Synthesis Example 5

### Synthesis of Polymer Compound Using Compound of [Chemical Formula IV]

A polymer compound was synthesized using the compound of [Chemical Formula IV] according to [Scheme 7].

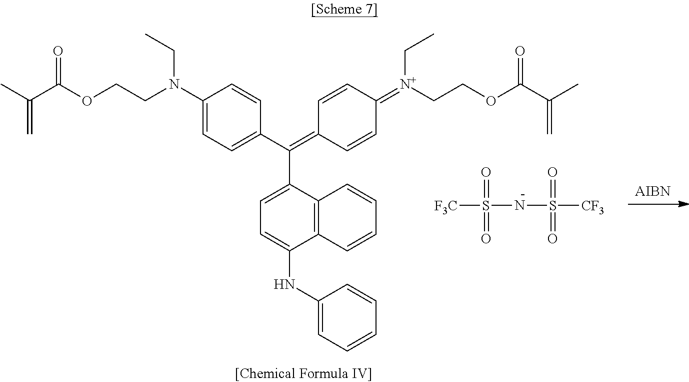 [SMILES: C=C(C)C(=O)OCCN(CC)c1ccc(C(=C2C=CC(=[N+](CC)CCOC(=O)C(=C)C)C=C2)c2ccc(Nc3ccccc3)c3ccccc23)cc1 ; O=S(=O)(NS(=O)(=O)C(F)(F)F)C(F)(F)F]

Under nitrogen atmosphere, methyl ethyl ketone (30 g) was heated to 70° C. The compound of [Chemical Formula IV] (2.54 g) and 2,2′-azobisisobutyronitrile (0.16 g) dissolved in methyl ethyl ketone (20 g) were added to the reactor for 3 hours while maintaining temperature at 70° C. After the addition was completed, the mixture was maintained at 70° C. for 15 hours. After partially concentrating the methyl ethyl ketone and adding the reaction mixture to hexane, the resulting product was filtered and dried to obtain a polymer compound (2.44 g).

Number-average molecular weight=3310, weight-average molecular weight=3594, polydispersity=1.09.

### Synthesis Example 6

### Synthesis of Polymer Compound Using Compound of [Chemical Formula IV]

A polymer compound was synthesized using the compound of [Chemical Formula IV] according to [Scheme 8].

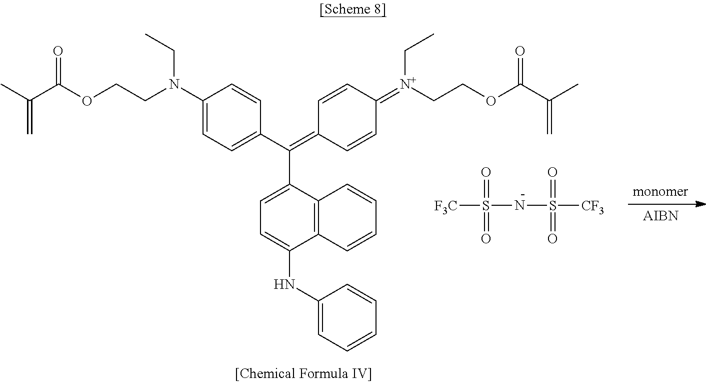 [SMILES: C=C(C)C(=O)OCCN(CC)c1ccc(C(=C2C=CC(=[N+](CC)CCOC(=O)C(=C)C)C=C2)c2ccc(Nc3ccccc3)c3ccccc23)cc1 ; O=S(=O)(NS(=O)(=O)C(F)(F)F)C(F)(F)F]

Under nitrogen atmosphere, methyl ethyl ketone (30 g) was heated to 70° C. The compound of [Chemical Formula IV] (2.54 g), 2,2′-azobisisobutyronitrile (0.25 g), benzyl methacrylate (0.51 g), methacrylic add (0.51 g) and N-phenylmaleimide (0.42 g) dissolved in methyl ethyl ketone (50 g) were added to the reactor for 3 hours while maintaining temperature at 70° C. After the addition was completed, the mixture was maintained at 70° C. for 15 hours. After partially concentrating the methyl ethyl ketone and adding the reaction mixture to hexane, the resulting product was filtered and dried to obtain a polymer compound (3.80 g).

Number-average molecular weight=4053, weight-average molecular weight=4421, polydispersity=1.09.

### Comparative Example 1

A compound of Comparative Example 1 was synthesized according to [Scheme 9].

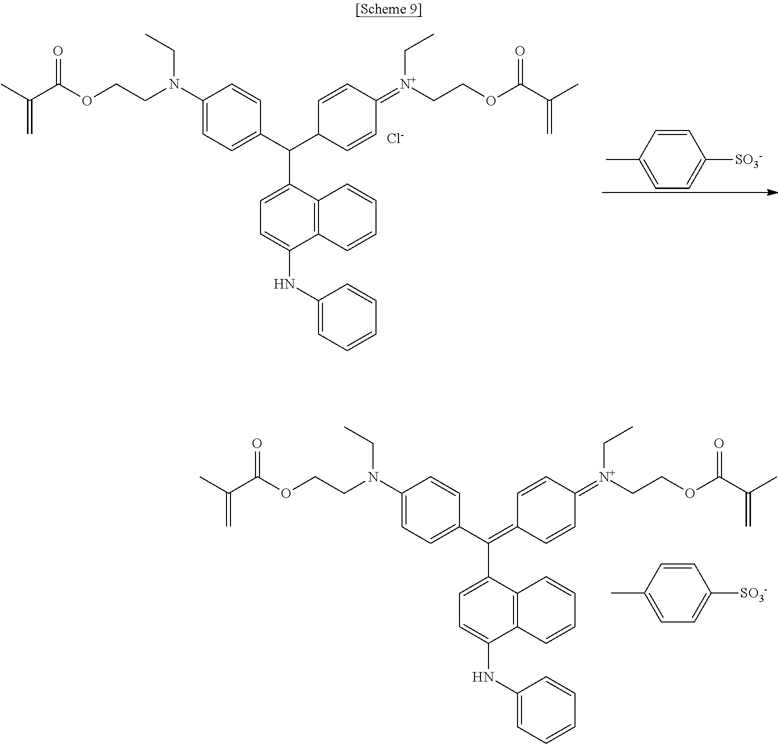

The compound of [Chemical Formula II] (5.00 g, 6.83 mmol) was dissolved by adding methanol (50 mL) and 20% aqueous solution of sodium p-toluenesulfonate (1.46 g, 7.51 mmol) was added. After filtration, the obtained compound was dissolved with CHCl₃, washed with water and concentrated under reduced pressure to obtain a compound of Comparative Example 1 (2.84 g, 3.28 mmol).

### Comparative Example 2

A compound of Comparative Example 2 was synthesized according to [Scheme 10],

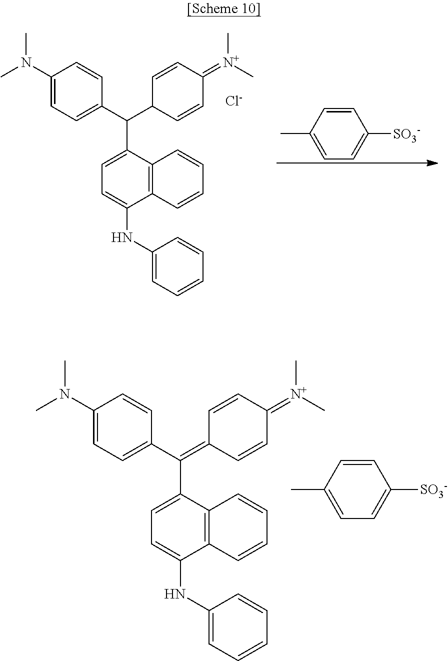

Basic blue 26 (5.00 g, 9.84 mmol) was dissolved by adding methanol (50 mL) and 20% aqueous solution of sodium p-toluenesulfonate (2.10 g, 10.82 mmol) was added. After filtration, the obtained compound was dissolved with CHCl₃, washed with water and concentrated under reduced pressure to obtain a compound of Comparative Example 2 (2.71 g, 4.23 mmol).

### Test Example 1

### Solubility

The blue dye compounds of Synthesis Examples 1-6 and Comparative Examples 1-2 were dissolved respectively in PGMEA and cyclohexanone and solubility was measured. The result is shown in [Table 1].

TABLE 1

| | Syn. | Syn. | Syn. | Syn. | Syn. | Syn. | Comp. | Comp. |
|---|---|---|---|---|---|---|---|---|
| | Ex. 1 | Ex. 2 | Ex. 3 | Ex. 4 | Ex. 5 | Ex. 6 | Ex. 1 | Ex. 2 |
| PGMEA | >10% | >10% | >2% | >4% | >3% | >5% | <1% | <1% |
| Cyclohex- | >10% | >10% | >10% | >10% | >10% | >10% | <3% | <3% |
| anone | | | | | | | | |

As seen from [Table 1], the blue dye compounds of Synthesis Examples 1 and 2 showed high solubility of greater than 10% in PGMEA and cyclohexanone. The copolymer compounds showed higher solubility than the homopolymer compounds. And, the solubility was higher when the anion was (CF₃SO₂)N⁻ as compared to when the anion was CF₃SO₃⁻. The compounds of Comparative Examples 1-2 showed relatively lower solubility than the compounds of Synthesis Examples 1-6. Accordingly, it was confirmed that the blue dye compound according to the present disclosure has superior solubility in an organic solvent.

### Examples 1-6

### Preparation of Blue Resin Composition for Color Filter

A photosensitive blue resin composition was prepared with the following composition.

(a) Binder resin: benzyl methacrylate/methacrylic acid (60:40, w/w) copolymer (M_{w}=20000) (2.7 g)

(b) Acryl monomer: dipentaerythritol pentaacrylate (10 g)

(c) Blue dye compound: compound of Synthesis Examples 1-6 (2.3 g)

(d) Photopolymerization initiator: Irgacure OXE-01 (BASF) (2 g)

(f) Solvent: propylene glycol monomethyl ether acetate (83 g)

### Comparative Examples 1-2

A photosensitive blue resin composition was prepared with the same composition as in Examples 1-6, except for using the compound prepared in Comparative Examples 1-2 instead of the compound of Synthesis Examples 1-6.

### Test Example 2

### Transmittance and Heat Resistance

For measurement of transmittance and heat resistance, the blue resin composition for a color filter of Examples 1-6 and Comparative Examples 1-2 was spin coated on a 10 cm×10 cm glass substrate to a thickness of 2 μm. After prebaking on a hot plate of 90° C. for 3 minutes, followed by cooling at room temperature for 1 minute, the glass substrate was exposed to light with 100 mJ/cm² (based on 365 nm).

Subsequently, after postbaking in a convection oven of 220° C. for 30 minutes, UV-Vis spectrum was recorded using the UV/vis spectrophotometer Agilent 8453 (Agilent) and ΔE_{ab}* was measured using the spectrophotometer MCPD3000 (Otsuka Electronics). The result is shown in [Table 2].

TABLE 2

| | | | | | | | Comp. | Comp. |
|---|---|---|---|---|---|---|---|---|
| | Ex. 1 | Ex. 2 | Ex. 3 | Ex. 4 | Ex. 5 | Ex. 6 | Ex. 1 | Ex. 2 |
| ΔE_{ab}* | 6.57 | 4.32 | 5.24 | 4.87 | 3.50 | 2.80 | 22.41 | 34.83 |

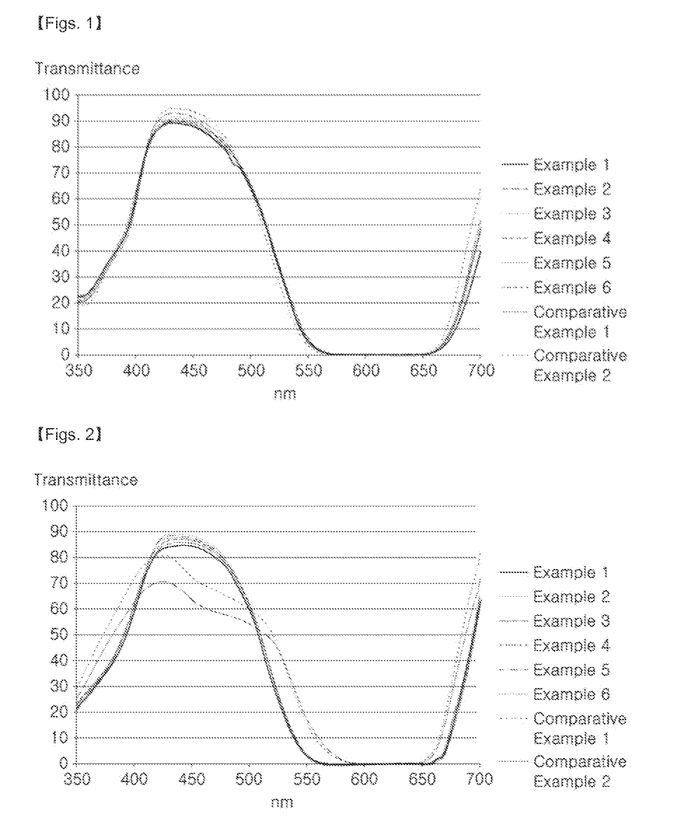

FIG. 1 shows the UV-vis spectra of the blue resin compositions of Examples 1-6 and Comparative Examples 1-2 after exposure to light and FIG. 2 shows the UV-vis spectra of the blue resin compositions of Examples 1-6 and Comparative Examples 1-2 after postbaking at 220° C. for 30 minutes.

As can be seen from [Table 2] and FIGS. 1-2, since the blue resin compositions according to the present disclosure exhibits high transmittance of 90% or higher in the wavelength range of 430-460 nm, they can be used to prepare a color filter of high brightness. Also, they exhibited superior heat resistance with less change in transmittance and UV-vis spectra before and after the postbaking. In contrast, the blue resin compositions of Comparative Examples 1 and 2 showed significant difference before and after the postbaking.

### INDUSTRIAL APPLICABILITY

Since a triarylmethane blue dye compound according to the present disclosure has superior solubility in propylene glycol monomethyl ether acetate (PGMEA) as well as high heat resistance and brightness, it can be industrially used to prepare a color filter exhibiting superior heat resistance, light resistance and brightness.

1. A triarylmethane blue dye compound represented by [Chemical Formula 1]: 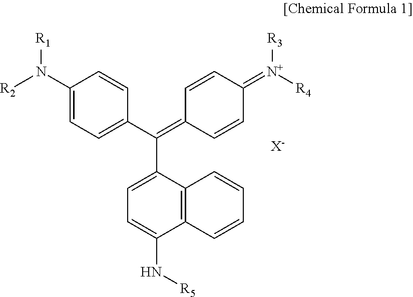
wherein
X⁻ is a trifluoromethanesulfonate or bis(trifluoromethane)sulfonimide anion,
each of R₁, R₂, R₃ and R₄ is independently selected from hydrogen, a substituted or unsubstituted C₁-C₁₀ alkyl group, a substituted or unsubstituted C₆-C₁₀ aromatic hydrocarbon and R₆ represented by [Structural Formula 1],
at least one of R₁, R₂, R₃ and R₄ comprises R₆ and
R₅ is phenyl, C₁-C₈ alkoxyphenyl or halogenated phenyl 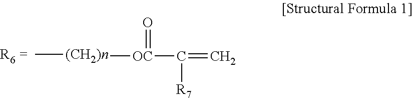
wherein
n is an integer from 1 to 10 and R₇ is hydrogen or methyl.

2. A homopolymer or copolymer blue dye compound comprising a structure represented by [Chemical Formula 2] as a polymer compound obtained from the triarylmethane compound represented by [Chemical Formula 1] according to claim 1 as a monomer: 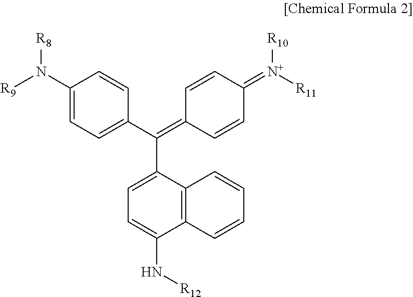
wherein
X⁻ is a trifluoromethanesulfonate or bis(trifluoromethane)sulfonimide anion,
each of R₈, R₉, R₁₀ and R₁₁ is independently selected from hydrogen, a substituted or unsubstituted C₆-C₁₀ aromatic hydrocarbon and R₁₃ represented by [Structural Formula 2],
at least one of R₈, R₉, R₁₀ and R₁₁ comprises R₁₃ and
R₁₂ is phenyl, C₁-C₈ alkoxyphenyl or halogenated phenyl 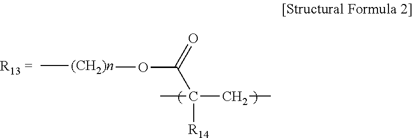
wherein
n is an integer from 1 to 10 and R₁₄ is hydrogen or methyl.

3. The homopolymer or copolymer blue dye compound according to claim 2, wherein the polymer compound has a weight-average molecular weight (M_{w}) of 2,000-150,000.

4. The triarylmethane blue dye compound according to claim 1, wherein the compound represented by [Chemical Formula 1] is a compound represented by [Chemical Formula 3] or [Chemical Formula 4];

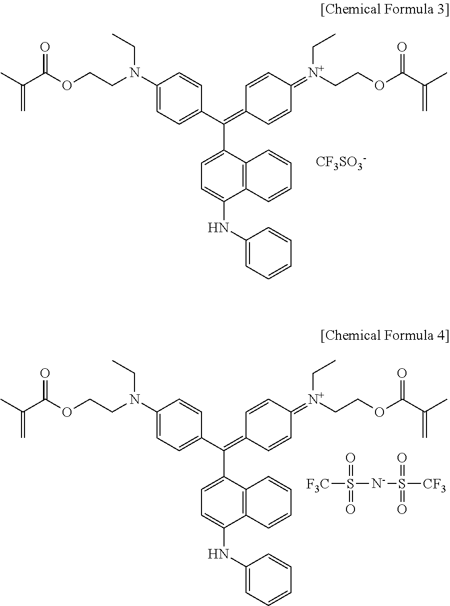

5. The homopolymer or copolymer blue dye compound according to claim 2, wherein the polymer compound comprising the structure represented by [Chemical Formula 2] is a homopolymer or a copolymer obtained from a compound represented by [Chemical Formula 3] or [Chemical Formula 4] as a monomer:

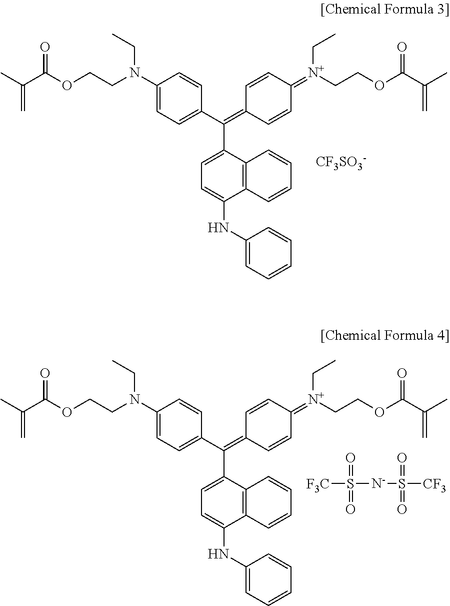

6. A blue resin composition for a color filter, comprising: a blue dye compound; a binder resin; a reactive unsaturated compound; a polymerization initiator; an organic solvent; and an additive,
wherein the blue dye compound is the blue dye compound represented by 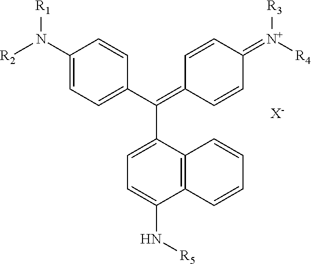
[Chemical Formula 1]
wherein
X⁻ is a trifluoromethanesulfonate or bis(trifluoromethane)sulfonimide anion,
each of R₁, R₂, R₃ and R₄ is independently selected from hydrogen, a substituted or unsubstituted C₁-C₁₀ alkyl group, a substituted or unsubstituted C₆-C₁₀ aromatic hydrocarbon and R₆ represented by [Structural Formula 1],
at least one of R₁, R₂, R₃ and R₄ comprises R₆ and
R₅ is phenyl, C₁-C₈ alkoxyphenyl or halogenated phenyl
[Structural Formula 1] 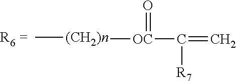
wherein
n is an integer from 1 to 10 and R₇ is hydrogen or methyl,
or the homopolymer or copolymer blue dye compound obtained from the compound represented by 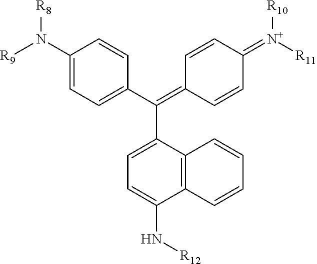
[Chemical Formula 2] as a monomer according to claim 2
wherein
X⁻ is a trifluoromethanesulfonate or bis(trifluoromethane)sulfonimide anion,
each of R₈, R₉, R₁₀ and R₁₁ is independently selected from hydrogen, a substituted or unsubstituted C₆-C₁₀ aromatic hydrocarbon and R₁₃ represented by [Structural Formula 2],
at least one of R₈, R₉, R₁₀ and R₁₁ comprises R₁₃ and
R₁₂ is phenyl, C₁-C₈ alkoxyphenyl or halogenated phenyl
[Structural Formula 2] 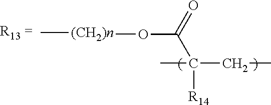
wherein
n is an integer from 1 to 10 and R₁₄ is hydrogen or methyl.

7. The blue resin composition for a color filter according to claim 6, wherein the blue dye compound further comprises one or more selected from a xanthene dye, a cyanine dye and an azaporphyrin dye.

8. The blue resin composition for a color filter according to claim 6, wherein the blue dye compound is contained in an amount of 0.01-50 wt % based on the total weight of the blue resin composition.

9. The blue resin composition for a color filter according to claim 6, wherein the blue resin composition further comprises a blue pigment and the blue pigment is a copper phthalocyanine-based blue pigment.

10. The blue resin composition for a color filter according to claim 6, wherein the reactive unsaturated compound is selected from a group consisting of a thermosetting monomer or oligomer, a photocurable monomer or oligomer and a combination thereof.

11. The blue resin composition for a color filter according to claim 6, wherein the polymerization initiator is selected from a group consisting of a thermal polymerization initiator, a photopolymerization initiator and a combination thereof.

12. A color filter prepared using the blue resin composition for a color filter according to claim 6.
